(19) United States
(12) Patent Application Publication
(10) Pub. No.: US 2026/0308442 A1
(43) Pub. Date: Oct. 8, 2026

(54) Formation Maintenance Fluids with Flowback Enhancers to Improve Wellbore Operations

(71) Applicant: Baker Hughes Oilfield Operations LLC, Houston, TX (US)

(72) Inventors: Gianna Pietrangeli, Houston, TX (US); Carlos Toro, Bogota (CO); Carlos Reyes, Bogota (CO); Luis Molina, Bogota (CO); Daniela Serrano, Bogota (CO); Sebastian Mesa, Conroe, TX (US); Maria Pineda, Bogota (CO)

(73) Assignee: Baker Hughes Oilfield Operations LLC, Houston, TX (US)

(21) Appl. No.: 19/172,225

(22) Filed: Apr. 7, 2025

(51) Int. Cl. C09K 8/60; C09K 8/035; C09K 8/42; C09K 8/52; C09K 8/584; C09K 8/86; E21B 33/138; E21B 37/06

(52) U.S. Cl. CPC C09K 8/602; C09K 8/035; C09K 8/42; C09K 8/52; C09K 8/584; C09K 8/86; E21B 33/138; E21B 37/06; C09K 2208/12

(57) ABSTRACT

Various formation maintenance fluids incorporate a synergistic combination of flowback enhancers and operations fluids to perform wellbore operations without formation damage. In one aspect, a flowback enhancer combines a surfactant package and wellbore protectant. The surfactant package includes a surfactant, a solvent, and a co-solvent, whereas the wellbore protectant includes scale inhibitors, clay hydration inhibitors, fines control agents, or combinations of the same. Suitable operations fluids include drilling fluids, drill-in fluids, competition fluids, workover fluids, cementing fluids, cleaning fluids, breakers, and displacement fluids.

### FIELD OF THE INVENTION

The subject matter disclosed herein generally relates to compositions and processes for performing a wellbore operation with a formation maintenance fluid that incorporates a flowback enhancer.

### BACKGROUND OF THE INVENTION

When selecting fluids for a wellbore operation, the fluids must be compatible with the applicable reservoir and formation. Water-based fluids are often selected to invade oil-bearing formations because these formations are preferentially water-wet, such that oil and gas are displaced from the rock during filtrate invasion. Despite their general compatibility, water-based fluids may create filtrate imbibition that damages the formation, leading to production impairment. A common type of formation damage is caused when filtrate from the water-based fluids changes the water-wet condition of the rock, thus altering the relative permeability of the native fluids. Filtrate invasion can create a series of other problems including connate filtrate, scaling, fines migration, clay swelling, and emulsion formation. Due to large filtrate volumes, controlling the invasion to the formation is not always possible. If the filtrate is not ultimately produced back, the resulting water block will impair productivity. These productivity losses are especially detrimental for long horizontal wells because formation damage, if produced, cannot be bypassed by perforations.

Certain mitigating chemicals have been proposed to reduce formation damage caused by water-based fluids. Chelating agents, for example, are sometimes deployed in the oil field to mitigation formation damage. The deployment of these chemicals is limited, however, by wettability of the rock, compatibility with native fluids, and mobility of filtrate within the reservoir. If the filtrate already has a high imbibition, these traditional products will not be efficiently delivered into the formation.

Accordingly, there is a need to implement effective chemistries and processes to reduce formation damage during wellbore operations. It is to this and other objects that the embodiments of the present disclosure are directed.

### SUMMARY OF THE INVENTION

The inventive concepts disclosed are generally directed to compositions and processes for performing a wellbore operation with a formation maintenance fluid that incorporates a flowback enhancer.

In one aspect, a flowback enhancer combines a surfactant package and wellbore protectant. The surfactant package includes between about 2 vol. % and about 67 vol. % surfactant, between about 0.1 vol. % and about 60 vol. % solvent, and between about 3 vol. % and about 20 vol. % a co-solvent based on the total volume of the surfactant package, whereas the wellbore protectants includes a scale inhibitor, a clay hydration inhibitor, and a fines control agent.

In another aspect, a formation maintenance fluid includes an operations fluid and a flowback enhancer, the latter of which includes a surfactant package and a wellbore protectant. The surfactant package includes a surfactant, a solvent, and a co-solvent, wherein the co-solvent is an alcohol that includes a carbon chain of between 5 and 10 carbon atoms. The wellbore protectant is a scale inhibitor, clay hydration inhibitor, fines control agent, or combination of the same.

In yet another aspect, a method of performing a wellbore operation includes the steps of providing a formation maintenance fluid, which includes an operations fluid and a flowback enhancer, and deploying the formation maintenance fluid downhole to accomplish the wellbore operation. The flowback enhancer includes a surfactant package with a surfactant, a solvent, and a co-solvent. The flowback enhancer also includes a wellbore protectant that includes scale inhibitors, clay hydration inhibitors, fines control agent, or combinations of the same.

### BRIEF DESCRIPTION OF DRAWINGS

The above and other objects and advantages of this invention may be more clearly seen when viewed in conjunction with the accompanying drawing wherein:

FIG. 1 is a pseudo-ternary phase diagram for the aqueous and oil-based phases of microemulsions, liquid crystals, nanoemulsions, and swollen micelles produced by surfactant packages in accordance with exemplary embodiments.

FIGS. 2A and 2B depict the results for return-to-flow tests performed with and without a flowback enhancer formulated in accordance with exemplary embodiments.

FIG. 3A depicts emulsion tendency results for sample bottles with and without a flowback enhancer formulated in accordance with exemplary embodiments at an interval before shaking.

FIG. 3B depicts emulsion tendency results for sample bottles with and without a flowback enhancer formulated in accordance with exemplary embodiments at an interval at 5 minutes after shaking.

FIG. 3C depicts emulsion tendency results for sample bottles with and without a flowback enhancer formulated in accordance with exemplary embodiments at an interval at 30 minutes after shaking.

FIG. 3D depicts emulsion tendency results for sample bottles with and without a flowback enhancer formulated in accordance with exemplary embodiments at an interval at 120 minutes after shaking.

### DETAILED DESCRIPTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

It has been discovered that the introduction of certain surfactant packages and tailored additives to an operations fluid provides a synergistic effect that improves the operations fluid's functionality. In particular, formation damage related to scales, fines migration, wettability changes, and capillary effects is significantly reduced by these synergistic combinations. Accordingly, compositions and processes are disclosed herein for mitigating formation damage during a wellbore operation to maximize flow assurance and production efficiency.

In some embodiments, a flowback enhancer is formulated with a surfactant package and a wellbore protectant. The surfactant package includes a surfactant, a solvent, a co-solvent, and optionally water. The wellbore protectant may include one or more of the following components: scale inhibitors, clay hydration inhibitors, fines control agents, linkers, iron control agents, hydrogen sulfide inhibitors, corrosion inhibitors, and inhibitors or dispersants for asphaltenes, wax, or both. The flowback enhancer is preferably formulated with a surfactant package and wellbore protectant that are compatible with native fluids (e.g., gases, formation waters, crude oils ranging from heavy to ultra-light) in a reservoir of interest.

In the concentrated flowback enhancer, the surfactant package produces one or more microemulsions, one or more liquid crystals, or a combination of microemulsions and liquid crystals. As used herein, the term “microemulsion” refers to a thermodynamically stable fluid having aqueous and oil-based phases stabilized by an interfacial film of surfactant molecules. These microemulsions form bi-continuous structures and can be prepared with little or no input of mechanical energy. The term “liquid crystal,” on the other hand, refers to a phase having properties between those of conventional liquids and those of solid crystals. These phases occur in solutions of surface-active materials as concentration is increased from that of a dilute solution to that of a saturated system in which special arrangement of the species would occur. As discussed in greater detail below, the surfactant package provides the surfactants and all or a portion of the aqueous and oil-based phases that make up the microemulsions/liquid crystals in the flowback enhancer.

The surfactant of the surfactant package may be a non-ionic surfactant, an anionic surfactant, a cationic surfactant, a zwitterionic surfactant, an amphoteric surfactant, or a blend of one or more of these surfactant types. Suitable non-ionic surfactants include alkyl polyglycosides, esters (e.g., sorbitan esters, polyglycol esters, methyl glucoside esters), and ethoxylated compounds (e.g., alcohol ethoxylates, ethoxylated fatty acids, and ethoxylated castor oil). Suitable anionic surfactants include sulfates and sulfonates (e.g., alkali metal alkyl sulfates, alkyl and alkylaryl sulfonates, linear and branched alkyl ether sulfates and sulfonates, alcohol polypropoxylated and/or polyethoxylated sulfates, alkyl and alkylaryl disulfonates, alkyl disulfates, linear and branched ether sulfates such as alkyl ether sulfates), alkyl sulphosuccinates, carboxylates (e.g., alkyl ether carboxylates, alkyl linear and branched carboxylates), alkylenediamides, and mixtures thereof. If a cationic surfactant, the surfactant may be arginine methyl esters or alkanolamines, and if an amphoteric surfactant, betaines are suitable non-limiting examples for the surfactant. If a zwitterionic surfactant, the surfactant may be hydroxysultaines, propyl betaines, amine oxides, and mixtures thereof. Other suitable surfactant types include silicone-based surfactants, fluorosurfactants, and resins.

The solvent in the surfactant package contributes to the oil-based phase of the microemulsions/liquid crystals created in the flowback enhancer. The term “oil” in “oil-based phase” is understood to refer to any water-insoluble liquid. In various embodiments, the solvent is aromatic. Suitable solvents include esters (including but not limited to fatty acid ester, methyl aliphatic carboxylic acid ester, and methyl ester), alkyl aliphatic carboxylic acid, pyrolysis oils (e.g., oils derived from citrus waste), and hydrocarbons such as terpenes and BTEX compounds (i.e., mixtures of benzene, toluene, ethylbenzene, and xylene). The co-solvent, on the other hand, is generally alcohol-based and includes one or more alcohols, where the term “alcohol” is understood to refer to any compounds having one or more hydroxyl groups attached to a carbon atom, including without limitation glycols and phenols. In various embodiments, the co-solvent includes an alcohol having a carbon chain of between 5 and 10 carbon atoms (a “long-chain alcohol”). Suitable long-chain alcohols include amyl alcohols, pentanol, hexanol, heptanol, octanol, 2-ethyl-hexanol, glycols such as ethylene glycol, polyethylene glycol, propylene glycol, triethylene glycol, and alkylene glycols (including polyalkylene glycols) and salts of the listed glycols.

When present, the water in the surfactant package contributes to the aqueous phase of the microemulsions/liquid crystals in the flowback enhancer. The water may be fresh water or brine (e.g., monovalent brine), and the water optionally includes one or more types of carboxylate salts.

Exemplary concentrations for the above components are herein provided with reference to the total volume of the surfactant package. The surfactant may be present in concentrations between about 2 volume % (vol. %) and about 67 vol. %, more particularly between about 5 vol. % and about 50 vol. %, more particularly between about 10 vol. % and about 40 vol. %, more particularly about 25 vol. %. The solvent may be present in concentrations between about 0.1 vol. % and about 60 vol. %, more particularly between about 1 vol. % and about 40 vol. %, more particularly between about 5 vol. % and about 25 vol. %. Suitable concentrations for the co-solvent include between about 3 vol. % and about 20 vol. %, more particularly between about 6 vol. % and about 15 vol. %, more particularly about 8 vol. %. In general, the water may supply the balance of the surfactant package. In various embodiments, the concentration of water is between about 10 vol. % and about 70 vol. %, more particularly between about 20 vol. % and about 50 vol. %, more particularly about 40 vol. %.

In one embodiment, the surfactant package includes between about 40 vol. % and about 67 vol. % surfactant, between about 15 vol. % and about 25 vol. % solvent, between about 8 vol. % and about 20 vol. % co-solvent, and between about 10 vol. % and about 40 vol. % water. In another embodiment, the surfactant package includes between about 15 vol. % and about 25 vol. % surfactant, between about 10 vol. % and about 40 vol. % solvent, between about 5 vol. % and about 15 vol. % co-solvent, and between about 40 vol. % and about 70 vol. % water.

The surfactant package optionally includes a co-surfactant. The co-surfactant may be an alcohol having a carbon chain of between 1 and 4 carbon atoms (a “short-chain alcohol”). Suitable short-chain alcohols include methanol, ethanol, propanol, butanol, ethylene glycol, propylene glycol, and glycerol. The co-surfactant may be present in concentrations between about 0.1 vol. % and about 60 vol. %, more particularly between about 10 vol. % and about 40 vol. %, based on the total volume of the surfactant package.

In one embodiment, the surfactant package includes between about 5 vol. % and about 10 vol. % surfactant, between about 0.1 vol. % and about 1 vol. % solvent, between about 5 vol. % and about 10 vol. % co-solvent, between about 40 vol. % and about 60 vol. % co-surfactant, and between about 20 vol. % and about 40 vol. % water. In another embodiment, the surfactant package includes between about 15 vol. % and about 25 vol. % surfactant, between about 10 vol. % and about 40 vol. % solvent, between about 5 vol. % and about 15 vol. % co-solvent, between about 0.1 vol. % and about 10 vol. % co-surfactant, and between about 40 vol. % and about 70 vol. % water.

As used herein, ranges of concentrations should be interpreted to include any and all concentrations within the prescribed ranges. It will therefore be understood that, as used herein, a range between X vol. % and Y vol. % will be interpreted to include the disclosure of each discrete integer value between X and Y (e.g., X, X+1, X+2 . . . . Y-1, Y).

Turning to the wellbore protectant, this component of the flowback enhancer incorporates chemicals that are tailored to minimize damage to a formation of interest. Scale inhibitors and clay hydration inhibitors (i.e., shale inhibitors) serve respectively to delay, reduce, or outright prevent scale deposition and to prevent swelling and destabilization of shales. Suitable scale inhibitors include ethylenediamine tetraacetic acid (EDTA) and derivatives thereof (e.g., tetrasodium EDTA di-sodium, tetrasodium EDTA tetrahydrate, disodium EDTA dehydrate), glutamic acid diacetate (GLDA), methyl alcohols, neutralized or acidic phosphonate salts, and carboxylic acids such as citric and tartaric. Suitable clay hydration inhibitors include chloride salts (e.g., potassium chloride, ammonium chloride, choline chloride), hydroxide salts (e.g., calcium hydroxide, potassium hydroxide), aluminum salts (e.g., poly aluminum chloride (PAC)), polyamines, partially hydrolyzed polyacrylamide (PHPA), sulphonate asphalts, lignite, and sodium- or potassium-based silicates. Fines control agents may be used as stabilizers for fines originating from the formation of interest. Suitable fines control agents include silane-based products, cationic polymers (e.g., cationic inorganic polymers such as hydroxyl aluminum (OH—Al) and zirconium oxychloride (ZrOCl); cationic organic polymers (COP); cationic polyelectrolytes such as polydiallaydimethyleamine chloride), ammonium salts (e.g., di-2-methylbutyleammonium chloride and tetramethyl ammonium chloride (TMAC)), and polyacrylamides.

Linkers in the wellbore protectant are used to increase solubilization, stabilize the surfactant package, and modify the interfacial properties of the surfactant package. Suitable linkers include lipophilic and hydrophilic molecules that segregate, respectively, near the interface of the hydrophobic chain for the surfactant and the interface of the hydrophilic head of the surfactant. In various embodiments, the linker is a fatty acid (e.g., oleic acid), an amine, carboxylic acid, or an alcohol (e.g., glycol, phenol) having more than 8 carbon atoms.

The iron control agent in various embodiments is citric acid, acetic acid, or erythorbic acid; and suitable hydrogen sulfide inhibitors include triazine, nitrite-based scavengers, and caustic soda.

Suitable corrosion inhibitors include alcohol-based compounds (e.g., isopropanol, propargyl alcohol, and methanol), amine-based compounds, quaternary ammonium compounds, thiourea formaldehyde copolymers, and tyrosine. In some embodiments, the corrosion inhibitor is combined with one or more biocides, oxygen scavengers, or both.

Suitable wax and asphaltene dispersants include mixtures of a base component (e.g., ethylene vinyl acetate, acetone, chloroform, BTEX based products, and combinations thereof) with one or more anionic/nonionic surfactants packages and one or more copolymers such as acrylate ester copolymer, polyacrylates, and alkane-maleic anhydrite. Other suitable wax and asphaltene dispersants are based on mutual solvents such as resins and glycol ethers (e.g., ethylene glycol monobutyl ether (EGMBE), diethylene glycol butyl ether, dipropylene glycol methyl ether, tripropylene glycol butyl ether, and triethylene glycol butyl ether).

The contributions made by surfactant package components to the phases of microemulsions and/or liquid crystals in the flowback enhancer is discussed above. It will be appreciated that components of the wellbore protectant may also contribute to these aqueous and oil-based phases. In various embodiments, aqueous components of the wellbore protectant contribute to the aqueous phase, and any oily components of the wellbore protectant contribute to the oil-based phase.

In another aspect, the flowback enhancer is combined with an operations fluid to produce a formation maintenance fluid. In various embodiments, the operations fluid is water-based, and suitable operations fluids include drilling fluids, drill-in fluids, completion fluids, workover fluids, cementing fluids, cleaning fluids, breakers, and displacement fluids. The flowback enhancer improves the operations fluid's compatibility with native fluids in the reservoir, thus minimizing damage during wellbore operations. Exemplary wellbore operations include without limitation wellbore drilling operations, completion of an oil and gas well, workover operations, cementing operations, and clean outs of a wellbore.

The formation maintenance fluid may be prepared and provided by combining one or more operations fluids with a flowback enhancer. This preparation step is performed, either onsite or offsite, prior to pumping the formation maintenance fluid downhole for a wellbore operation. The type of flowback enhancer used for the formation maintenance fluid may be selected based on salinity concentrations, salt types, and temperatures of the operations fluid. Once the formation maintenance fluid is prepared, the concentration of the surfactant package therein may be between about 0.4 vol. % and about 0.8 vol. %, more particularly about 0.6 vol. %, based on the total volume of the formation maintenance fluid. The concentration of the wellbore protectant may be between about 0.1 vol. % and about 1 vol. %, more particularly between about 0.4 vol. % and about 0.8 vol. %, based on the formation maintenance fluid's total volume.

As noted above, in the concentrated flowback enhancer (i.e., before combination with the operations fluid), the surfactant package produces one or more microemulsions, liquid crystals, or combinations of microemulsions and liquid crystals. When the flowback enhancer is combined with the operations fluid, the surfactant package instead produces one or more nanoemulsions, swollen micelles, or combinations of the same in the resulting formation maintenance fluid. As used herein, the term “nanoemulsion” refers to a kinetically stable liquid-in-liquid two-phase dispersion with droplet sizes below 0.5 microns (μm). Unlike microemulsions, nanoemulsions are not thermodynamically stable systems. When a nanoemulsion is formed by diluting microemulsions/liquid crystals, the low- or zero-energy emulsification characteristics of the original structures create enhanced stability for the resulting nanoemulsion, while preserving energy from the predecessor structures in the new structure. This phenomenon is known as emulsification by phase transition/inversion or persuasion. The term “swollen micelle”, on the other hand, refers to an aggregate of surfactant molecules (e.g., oil-in-water or water-in-oil aggregates) with a large and diffuse hydrophobic core. Unlike microemulsions, which have a sponge-like structure and a clear boundary between hydrophobic and hydrophilic regions, swollen micelles have no strictly hydrophobic core. The swollen micelles created in the formation maintenance fluid will generally be more stable when one or more linkers are included in the flowback enhancer.

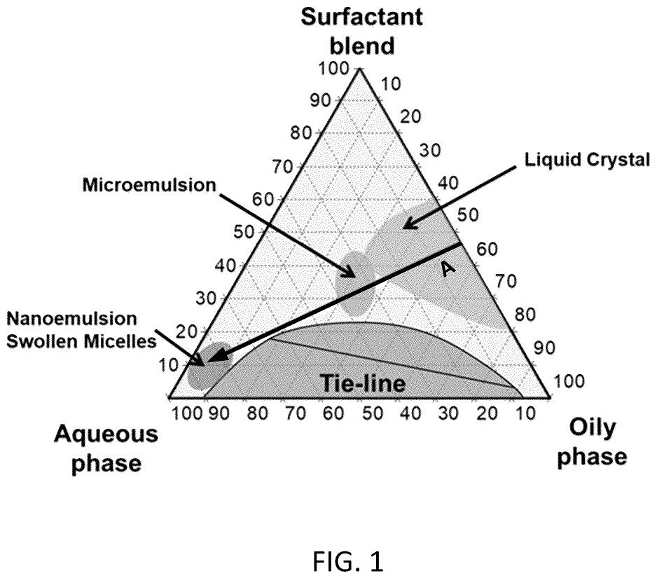

The “A” arrow in the pseudo-ternary phase diagram of FIG. 1 depicts the dilution of microemulsions/liquid crystals (i.e., in the flowback enhancer) to nanoemulsions/swollen micelles (i.e., in the formation maintenance fluid). In various embodiments, the aqueous phase(s) in the formation maintenance fluid include the water of the surfactant package and aqueous components, if any, of the operations fluid, whereas the oil-based phase(s) include the solvent of the flowback enhancer and oily components of the operations fluid. For example, where the operations fluid is brine-based, the oil-based phase of the formation maintenance fluid may include these brine components.

Combining the flowback enhancer with the operations fluid improves fluids filtrate imbibition downhole by decreasing capillary pressure, thus enhancing relative permeability values within the reservoir, controlling scale formation and deposition, reducing clay swelling and connate filtrate, lowering emulsion tendencies, decreasing mobilization of fines, and decreasing organic deposits. These outcomes improve product deployment within the reservoir, diminish water blocks, enhance the mobility of native fluids, and expedite filtrate return.

### EXAMPLES

The composition and process for performing a wellbore operation with a formation maintenance fluid that incorporates a flowback enhancer is further illustrated by the following Examples, which are provided for the purpose of demonstration rather than limitation.

### Example 1

A return permeability test was conducted with native sandstone cores from the Llanos basin Colombia to compare the performance of (i) a water-based operations fluid without a flowback enhancer (the “blank”) with that of (ii) the same operations fluid having a flowback enhancer (“Formation Maintenance Fluid 1” or “FMF1”). The flowback enhancer used for FMF1 had the surfactant package shown in Table 1 (“Surfactant Package 1”).

TABLE 1
Surfactant Package 1

| Component | | Concentration (vol. %) |
|---|---|---|
| Surfactant | Non-ionic surfactant | 5-10 |
| Solvent | Aromatic solvent | 0.1-1 |
| Co-solvent | Alcohol with a carbon chain of | 5-10 |
| | between 5 and 10 carbon atoms | |
| Co-surfactant | Alcohol with a carbon chain of | 40-60 |
| | between 1 and 4 carbon atoms | |
| Aqueous phase | Water | 20-40 |

The composition for FMF1 is shown in Table 2.

TABLE 2
Formation Maintenance Fluid 1 (FMF1)

| | |
|---|---|
| Component | Concentration (with units) |

| | | | |
|---|---|---|---|
| Operations | Sodium formate | 7 | ppb. |
| fluid | completion brine | | |
| Flowback | Surfactant Package 1 | 0.3 | vol. % |
| enhancer | Corrosion inhibitor | 0.12 | vol. % |
| | Dispersant | 0.3 | vol. % |

| | | |
|---|---|---|
| Biocide | 0.5 | ppb. |
| Buffer | 0.4 | ppb. |
| pH control | 0.2 | ppb. |

During testing, a first sandstone core was exposed to the blank with cement filtration. The return permeability was about 75% when crude oil was subsequently flowed through the core. In comparison, when a second sandstone core was exposed to FMF1, the return permeability was 91.9%.

### Example 2

Another return permeability test was conducted with sandstone core to compare the performance of (i) a water-based operations fluid without a flowback enhancer (the “blank”) with the performance of (ii) the same operations fluid with a flowback enhancer (“Formation Maintenance Fluid 2” or “FMF2”), where the flowback enhancer used the surfactant package of Table 3 (“Surfactant Package 2”).

TABLE 3
Surfactant Package 2

| Component | | Concentration (vol. %) |
|---|---|---|
| Surfactant | Non-ionic surfactant | 40-67 |
| Solvent | Citric-based pyrolysis oil | 15-25 |
| | and hydrocarbons | |
| Co-solvent | Alcohol with a carbon chain of | 8-20 |
| | between 5 and 10 carbon atoms | |
| Aqueous phase | Water | 10-40 |

The composition for FMF2 is shown in Table 4.

TABLE 4
Formation Maintenance Fluid 2 (FMF2)

| Component | | Concentration (with units) | |
|---|---|---|---|
| Operations | 16.4 lb./gal. cesium formate | 0.8530 | bbl. |
| fluid | brine (drill-in fluid) | | |
| Flowback | Clay hydration inhibitor | | |
| enhancer | Surfactant Package 2 | 2 | vol. % |

| | | |
|---|---|---|
| Biocide | 0.1 | lb. |
| Water | 0.0537 | bbl. |
| Starch | 6 | lb. |
| Xanthan gum | 0.5 | lb. |
| Scavenger | 1 | lb. |
| Carbonates | 75 | lb. |

The blank and FMF2 were circulated across the faces of separate sandstone cores for 4 hours at 850 psi overbalance, with static overbalance performed for 12 hours. After mud lift off was performed, the sample was unloaded and desaturated, and permeability was measured. For the core that was subjected to the blank, return permeability after mud off was 29% and after centrifugation was 64%. In comparison, the return permeability for the FMF2 core was 21% after mud off and 93% after centrifugation. Liftoff pressure for the blank was 0.196 psi, while liftoff pressure for FMF2 was 1.21 psi.

### Example 3

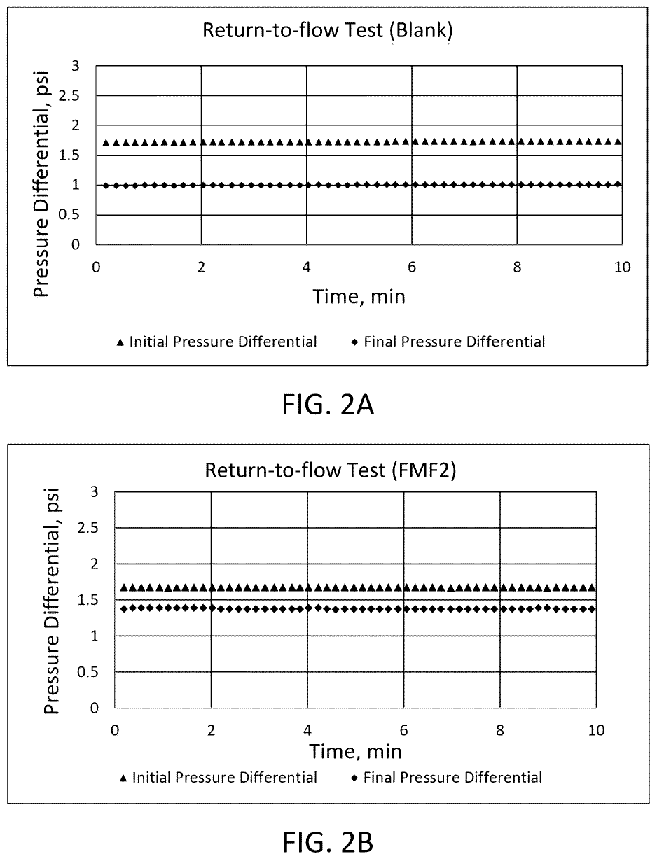

Return-to-flow tests were performed at 280° F. and 4 mL/min on a 12 μm disc with the blank and FMF2 of Example 2. A higher flow rate produced higher return-to-flow values for the tests. Depending on flow rates, the blank demonstrated return-to-flow results from 58% to 79%. In contrast, FMF2 showed return-to-flow values ranging from 82% to 96%, indicating an enhanced relative return permeability. FIGS. 2A and 2B depict, respectively, the pressure differentials for the blank and FMF2 return-to-flow tests.

### Example 4

Yet another return permeability test was conducted with Indiana limestone core to compare the performance of (i) a first water-based operations fluid (drilling mud) without a flowback enhancer (the “blank”) and (ii) a second water-based operations fluid (breaker) having a flowback enhancer (“Formation Maintenance Fluid 3” or “FMF3”). Table 5 shows the composition of the surfactant package for the flowback enhancer (“Surfactant Package 3”).

TABLE 5
Surfactant Package 3

| Component | | Concentration (vol. %) |
|---|---|---|
| Surfactant | Non-ionic surfactant | 15-25 |
| Solvent | Citric-based pyrolysis oil | 10-40 |
| Co-solvent | Alcohol with a carbon chain of | 5-15 |
| | between 5 and 10 carbon atoms | |
| Co-surfactant | Alcohol with a carbon chain of | 0.1-10 |
| | between 1 and 4 carbon atoms | |
| Aqueous phase | Water | 40-70 |

Table 5 depicts the composition for the blank.

TABLE 5
Blank for Example 4

| Component | Concentration (ppb) |
|---|---|
| NaCl brine | 364.00 |
| pH control | 0.55 |
| Buffer | 0.25 |
| Starch | 6.00 |
| Xanthan gum | 1.25 |
| Carbonates | 36 |
| Lubricant | 10.54 |
| H₂S scavenger | 1.00 |
| Corrosion inhibitor | 1.00 |
| Biocide | 0.15 |
| Oxygen scavenger | 0.25 |

Table 6 depicts the composition for FMF3.

TABLE 6
Formation Maintenance Fluid 3 (FMF3)

| Component | | Concentration (with units) | |
|---|---|---|---|
| Operations fluid | CaCl₂ brine (breaker) | 221.24 | lb./gal. |
| Flowback enhancer | Surfactant Package 3 | 1.0 | vol. % |
| | Corrosion inhibitor | 7.55 | lb./gal. |
| | Dispersant | 11.34 | lb./gal. |

| | | |
|---|---|---|
| Water | 113.67 | lb./gal. |
| Viscosifier | 1.40 | lb./gal. |
| Buffer | 4.0 | lb./gal. |
| Acid generator | 42.0 | lb./gal. |
| Enzyme for starches | 4.20 | lb./gal. |
| Enzyme for xanthan gum | 14.0 | lb./gal. |

The blank was first circulated across the faces of both limestone cores for 12 hours at 500 psi overbalance, with static overbalance performed for 12 hours. For the blank sample's core, mud liftoff was performed, the limestone core was unloaded and desaturated at 200 psi, the core was reloaded, and permeability was remeasured. Return permeability after mud off was 38%, return permeability after centrifugation was 44%, and liftoff pressure was 11.9 psi. For the FMF3 limestone core, one pore volume of FMF3 was injected after the initial circulation with the blank, and the FMF3 was circulated at 0.02 cc/min for 48 hours. After mud lift off, the sample was unloaded and desaturated at 200 psi, then reloaded for permeability remeasurement. The return permeability for the FMF3 core after mud off was 56%, the return permeability after centrifugation was 75%, and the liftoff pressure was 9.6 psi.

### Example 5

An emulsion tendency test was performed at 160° F. on (i) an operations fluid without a flowback enhancer (the “blank”) and (ii) the same operations fluid with a flowback enhancer that used Surfactant Package 1 (“Formation Maintenance Fluid 4” or “FMF4”). Table 7 depicts the composition for FMF4.

TABLE 7
Formation Maintenance Fluid 4 (FMF4)

| | |
|---|---|
| Component | Concentration (with units) |

| Operations fluid | | 0.9906 | lb./bbl. |
|---|---|---|---|
| Flowback | Surfactant Package 1 | 0.5 | vol. % |
| enhancer | Corrosion inhibitor | 0.12 | vol. % |
| | Scale inhibitor | 0.5 | vol. % |
| | Dispersant | 0.5 | vol. % |

| | | |
|---|---|---|
| Sodium formate | 7 | ppb. |
| Biocide | 0.5 | ppb. |
| Buffer | 0.4 | ppb. |
| pH control | 0.2 | ppb. |

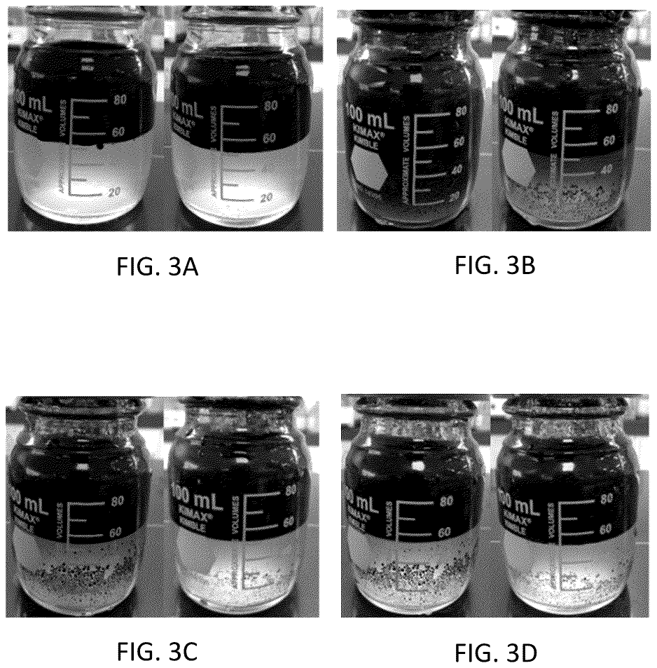

The samples were photographed at 0 minutes before the sample bottles were shaken (FIG. 3A), at 5 minutes after shaking (FIG. 3B), at 30 minutes after shaking (FIG. 3C), and at 120 minutes after shaking (FIG. 3D). FIGS. 3A-3D each depict the sample bottle for the blank at the left and the FMF4 bottle at the right. After 30 minutes, the FMF4 bottle experienced complete separation with a clear interface, while the blank sample required at least 120 minutes to achieve the same separation quality.

### Example 6

A scale formation tendency test was performed at 160° F. for 24 hours to compare the performance of (i) a 50/50 mixture of formation water and completion brine without a flowback enhancer (Sample 1) and (ii) the same 50/50 mixture with a flowback enhancer (Sample 2). The flowback enhancer had the composition shown in Table 8. Sample 1 experienced scale precipitation, whereas Sample 2 did not.

TABLE 8
Flowback enhancer (Example 6)

| | Concentration based on | |
|---|---|---|
| Component | the total sample (with units) | |
| Surfactant Package 1 | 0.3 | vol. % |
| Clay hydration inhibitor | 2.0 | ppb |
| Scale inhibitor | 0.5 | vol. % |
| Dispersant | 0.9 | vol. % |
| Corrosion inhibitor | 0.5 | vol. % |

### Example 7

Rheology tests were performed to confirm that the flowback enhancer shown in Table 9 would not significantly affect the rheological properties of an operations fluid (drill-in fluid).

TABLE 9
Flowback enhancer (Example 7)

| | Concentration based on | |
|---|---|---|
| | the formation maintenance | |
| Component | fluid (with units) | |
| Surfactant Package 1 | 0.4 | vol. % |
| Clay hydration inhibitor | 1 | vol. % |
| Scale inhibitor | 0.4 | vol. % |
| Fines control agent | 0.1 | vol. % |

The results for the untreated and treated operations fluids (the blank and the formation maintenance fluid, respectively) before hot rolling (BHR) and after hot rolling (AHR) are depicted in Table 10. Based on these results, the properties of the operations fluid were not significantly changed by addition of the flowback enhancer. In fact, the AHR results indicate that flowback enhancer helped to stabilize the operations fluid's rheology parameters after hot rolling.

TABLE 10
Flowback enhancer (Example 7)

| | | | | Formation | |
|---|---|---|---|---|---|
| | | Blank | | maintenance fluid | |
| Properties | Units | BHR | AHR | BHR | AHR |
| Fluid Density | lb./gal. | 10.0 | 10.0 | 10.0 | 10.0 |
| 600 RPM | Dial reading | 88 | 64 | 80 | 64 |
| 300 RPM | Dial reading | 59 | 42 | 53 | 42 |
| 200 RPM | Dial reading | 46 | 33 | 42 | 32 |
| 100 RPM | Dial reading | 31 | 22 | 28 | 22 |
| 6 RPM | Dial reading | 6 | 3 | 5 | 3 |
| 3 RPM | Dial reading | 4 | 2 | 3 | 2 |
| Plastic | cP | 29 | 22 | 27 | 22 |
| Viscosity | | | | | |
| Yield Point | lb./100 ft² | 30 | 20 | 26 | 20 |
| 10 Second | lb./100 ft² | 4 | 2 | 4 | 3 |
| Gel | | | | | |
| 10 Minute | lb./100 ft² | 5 | 2 | 4 | 3 |
| Gel | | | | | |
| HTHP @ | mL/30 mins | — | 9.8 | — | 10.2 |
| 200° F., | | | | | |
| API - 12 disk | | | | | |
| (actual) | | | | | |

For purposes of the disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all the defined steps (except where context excludes that possibility).

Thus, the invention is adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

It is claimed:

1. A flowback enhancer comprising:
a surfactant package comprising:
between about 2 vol. % and about 67 vol. % surfactant,
between about 0.1 vol. % and about 60 vol. % solvent, and
between about 3 vol. % and about 20 vol. % co-solvent, based on the total volume of the surfactant package; and
a wellbore protectant comprising a scale inhibitor, a clay hydration inhibitor, and a fines control agent.

2. The flowback enhancer of claim 1, wherein the surfactant is a non-ionic surfactant selected from the group consisting of ethoxylated fatty acids and ethoxylated castor oil.

3. The flowback enhancer of claim 1, wherein the surfactant is an anionic surfactant selected from the group consisting of alkyl carboxylates and alkyl ether carboxylates.

4. The flowback enhancer of claim 1, wherein the surfactant is a zwitterionic surfactant selected from the group consisting of hydroxysultaines, propyl betaines, and amine oxides.

5. The flowback enhancer of claim 1, wherein the solvent is selected from the group consisting of pyrolysis oils, terpenes, and BTEX compounds, and the co-solvent is an alcohol comprising a carbon chain of between 5 and 10 carbon atoms.

6. The flowback enhancer of claim 1, wherein the scale inhibitor of the wellbore protectant is selected from the group consisting of ethylenediamine tetraacetic acid and derivatives thereof, glutamic acid diacetate, phosphonate salts, citric acid and tartaric acid.

7. The flowback enhancer of claim 6, wherein the clay hydration inhibitor is selected from the group consisting of chloride, hydroxide, and aluminum salts; sodium- and potassium-based silicates; sulphonate asphalts; and lignite.

8. The flowback enhancer of claim 7, wherein the fines control agent is selected from the group consisting of silane-based products, cationic inorganic polymers, cationic polyelectrolytes, and ammonium salts.

9. A formation maintenance fluid comprising:
an operations fluid; and
a flowback enhancer comprising:
a surfactant package comprising:
a surfactant;
a solvent, and
a co-solvent, wherein the co-solvent is an alcohol comprising a carbon chain of between 5 and 10 carbon atoms; and
a wellbore protectant selected from the group consisting of scale inhibitors, clay hydration inhibitors, fines control agents, and combinations of the same.

10. The formation maintenance fluid of claim 9, wherein the operations fluid is selected from the group consisting of sodium formate brine, cesium formate brine, and calcium chloride brine.

11. The formation maintenance fluid of claim 9, comprising between about 0.4 vol. % and about 0.8 vol. % surfactant package based on the total volume of the formation maintenance fluid.

12. The formation maintenance fluid of claim 11, wherein the wellbore protectant comprises about 1 vol. % clay hydration inhibitor, about 0.4 vol. % scale inhibitor, and about 0.1 vol. % fines control agent based on the formation maintenance fluid.

13. The formation maintenance fluid of claim 9, wherein the surfactant is a non-ionic surfactant selected from the group consisting of ethoxylated fatty acids and ethoxylated castor oil, and the solvent comprises citric-based pyrolysis oil.

14. The formation maintenance fluid of claim 9, wherein the wellbore protectant comprises a scale inhibitor selected from the group consisting of ethylenediamine tetraacetic acid and derivatives thereof, glutamic acid diacetate, phosphonate salts, citric acid, and tartaric acid.

15. The formation maintenance fluid of claim 14, wherein the wellbore protectant further comprises a clay hydration inhibitor selected from the group consisting of chloride, hydroxide, and aluminum salts; sodium- and potassium-based silicates; sulphonate asphalts; and lignite.

16. The formation maintenance fluid of claim 15, wherein the wellbore protectant further comprises a fines control agent selected from the group consisting of silane-based products, cationic inorganic polymers, cationic polyelectrolytes, and ammonium salts.

17. The formation maintenance fluid of claim 15, wherein the flowback enhancer further comprises a dispersant that comprises a glycol ether.

18. A method of performing a wellbore operation comprising:
providing a formation maintenance fluid comprising:
an operations fluid; and
a flowback enhancer comprising:
a surfactant package comprising a surfactant, a solvent, and a co-solvent; and
a wellbore protectant selected from the group consisting of scale inhibitors, clay hydration inhibitors, fines control agent, and combinations of the same; and
deploying the formation maintenance fluid downhole to accomplish the wellbore operation.

19. The method of claim 18, wherein the operations fluid is selected from the group consisting of drilling fluids, drill-in fluids, competition fluids, workover fluids, cementing fluids, cleaning fluids, breakers, and displacement fluids.

20. The formation maintenance fluid of claim 19,
wherein operations fluid is selected from the group consisting of sodium formate brine, cesium formate brine, and calcium chloride brine;
wherein the surfactant is a non-ionic surfactant selected from the group consisting of ethoxylated fatty acids and ethoxylated castor oil; an anionic surfactant selected from the group consisting of alkyl carboxylates and alkyl ether carboxylates; or a zwitterionic surfactant selected from the group consisting of hydroxysultaines, propyl betaines, and amine oxides;
wherein the solvent is selected from the group consisting of pyrolysis oils, terpenes, and BTEX compounds; and
wherein the co-solvent is an alcohol comprising a carbon chain of between 5 and 10 carbon atoms.
